(19) United States
(12) Patent Application Publication
(10) Pub. No.: US 2018/0136617 A1
(43) Pub. Date: May 17, 2018

(54) SYSTEMS AND METHODS FOR CONTINUOUSLY MODELING INDUSTRIAL ASSET PERFORMANCE

(71) Applicant: General Electric Company, Schenectady, NY (US)

(72) Inventors: Rui XU, Rexford, NY (US); Yunwen XU, Fremont, CA (US); Weizhong YAN, Clifton Park, NY (US)

(21) Appl. No.: 15/806,999

(22) Filed: Nov. 8, 2017

Related U.S. Application Data
(60) Provisional application No. 62/420,850, filed on Nov. 11, 2016.

(51) Int. Cl. G05B 13/02

(52) U.S. Cl. CPC G05B 13/0265; G05B 13/027

(57) ABSTRACT

A method of continuously modeling industrial asset performance includes an initial model build block creating a first model based on a combination of an industrial asset historical data, configuration data and training data, filtering at least one of the historical data, configuration data, and training data, and a continuous learning block predicting performance of one or more members of an ensemble of models by evaluating a result of the one or more ensemble members to a predetermined threshold. A model application block pushing a selected model ensemble member to a performance diagnostic center, selecting the member based on comparing model ensemble members to a fielded modeling algorithm. A system and computer-readable medium are disclosed.

### CLAIM OF PRIORITY

This patent application claims the benefit of priority, under 35 U.S.C. § 119, of U.S. Provisional Patent Application Ser. No. 62/420,850, filed Nov. 11, 2016, titled “SYSTEMS AND METHODS FOR PERFORMANCE MODELING WITH ONLINE ENSEMBLE REGRESSION” the entire disclosure of which is incorporated herein by reference.

### BACKGROUND

Industrial assets are engineered to perform particular tasks as part of industrial processes. For example, industrial assets can include, among other things and without limitation, generators, gas turbines, power plants, manufacturing equipment on a production line, aircraft engines, wind turbine generators, power plants, locomotives, healthcare or imaging devices (e.g., X-ray or MRI systems) for use in patient care facilities, or drilling equipment for use in mining operations. The design and implementation of these assets often takes into account both the physics of the task at hand, as well as the assets' operating environment and their specific operational mode(s).

Industrial assets can be complex and nonstationary systems. Modeling such systems using traditional machine learning modeling approaches are inadequate to properly model operations of such systems. One example of a complex industrial asset is a power plant. It would be desirable to provide systems and methods for performance modeling of such systems with continuous learning capability. As used herein, a particular example of an industrial asset (i.e., a power plant) is used to illustrate features of some embodiments. Those skilled in the art, upon reading this disclosure, will appreciate that the example is for illustrative purposes only, and other industrial assets of varying types and/or natures are within the scope of this disclosure. Features of some, and/or all, embodiments may be used in conjunction with other industrial assets.

### BRIEF DESCRIPTION OF THE DRAWINGS

FIG. 1 depicts a flowchart of a continuous modeling of industrial asset performance with an ensemble regression algorithm in accordance with embodiments;

FIG. 2 depicts a system for implementing an ensemble-based passive approach to model industrial asset performance in accordance with embodiments;

FIG. 3 depicts an example of an industrial asset's simulated data used in validating an ensemble of models in accordance with embodiments;

FIG. 4 depicts sensitivity of an ensemble regression algorithm to window size in accordance with embodiments;

FIG. 5A depicts performance of an ensemble regression algorithm over time with retraining in accordance with embodiments;

FIG. 5B depicts performance of the ensemble regression algorithm over time without retraining;

FIG. 6A depicts prediction error of an ensemble regression algorithm over time with retraining in accordance with embodiments; and

FIG. 6B depicts prediction error of an ensemble regression algorithm over time without retraining.

### DETAILED DESCRIPTION

In today's competitive business environment, operators or users of industrial assets (such as power plant owners) are constantly striving to reduce their operation and maintenance costs, thus increasing their profits. To operate industrial assets more efficiently, more efficient machines can be developed—e.g., next generation turbine machines. Advanced digital solutions (software and tools) can also be developed for plant operations. For example, a project referred to as the “Digital Power Plant”, a General Electric initiative to digitize industrial assets, is one of such technologies recently developed. Digital Power Plant involves building a collection of digital models (both physics-based and data-drive), or so-called “Digital Twins”, which are used to model the present state of every asset in a power plant. This transformational technology enables utilities to monitor and manage every aspect of the power generation ecosystem to generate electricity cleanly, efficiently, and securely.

A power plant is used herein as an illustrative example of an inherently dynamic system due to the physics driven degradation, different operation and control settings, and various maintenance actions. For example, the efficiency of a mechanical asset or equipment degrades gradually because of parts wearing from aging, friction between stationary and rotating parts, and so on. External factors, such as dust, dirt, humidity, and temperature can also affect the characteristics of these assets or equipment. The change of operation condition may cause unseen scenarios in observed data.

For example, for a combined cycle power plant, the on-off switch of a duct burner will lead to the relationship change between the power output and the corresponding input variables. The maintenance actions, particularly online actions, will usually cause sudden changes to the system behavior. A typical example is water wash of compressor, which could significantly increase its efficiency and lead to higher power output under similar environments.

Learning in nonstationary environments, also known as concept drift learning or learning in dynamics in the literature, has attracted lots of efforts for the past decades, particularly in the context of classification in the communities of machine learning and computational intelligence. Concept drift can be distinguished to two types—real drift, which refers to the change of the posterior probability, and virtual drift, which refers to the change of prior probability without affecting the posterior probability. The physical system degradation and operation condition change are real drifts. Insufficient data representation for initial modeling belongs to virtual drift.

Concept drift can also be classified into three types of patterns based on the change rate over time. Sudden drift indicates the drift happens abruptly from one concept to another (e.g., water wash of power gas turbine can increase the compressor efficiency—a hidden variable, which leads to the significant increase of power output). In contrast to sudden drift, gradual drift takes a longer period for concept evolving (e.g., the wear of parts leads to the degradation of a physical system). The drift can also be recurring with the reappearance of the previous concept.

Generally, adaptation algorithms for concept drift belong to two primary families—active approaches and passive approaches, based on whether explicit detection of change in the data is required. For the active approaches, the adaptation mechanism can be triggered after the change is detected. In contrast, passive approaches continuously learn over time, assuming that the change can happen at any time with any change pattern or rate.

Under the framework of active approaches, the drift detection algorithms monitor either the performance metrics or the characteristics of data distribution, and notify the adaptation mechanism to react to detected changes. Commonly used detection technologies include sequential hypothesis test, change detection test, and hypothesis tests. The major challenge to the adaptation mechanisms is to select the most relevant information to update the model. A simple strategy is to apply a sliding window, and only data points within the current window are used to retrain the model. The window size can be fixed in advance or adjusted adaptively. Instance weighting is another approach to address this problem, which assigns weights to data points based on their age or relative importance to the model performance. Instance weighting requires the storage of all previous data, which is infeasible for many applications with big data. An alternative approach is to apply data sampling to maintain a data reservoir that provides training data to update the model.

Passive approaches perform continuous update of the model upon the arrival of new data points. Passive approach is closely related to continuous learning and online learning. The continuously evolving learner can be either a single model or an ensemble of models. An embodying continuously evolving ensemble of models has advantages over a single model. Particularly, ensemble-based learning provides a very flexible structure to add and remove models from the ensemble, thus providing an effective balance in learning between new and old knowledge. Embodying ensemble-based passive algorithms can include the following aspects:

voting strategy—weighted voting is a common choice for many algorithms, but some authors argue the average voting might be more appropriate for nonstationary environment learning.

voting weights—if weighted voting is used, the weights are usually determined based on the model performance. For example, the weight for each learner is calculated as the difference of mean square errors between a random model and the learner. The Dynamic Weighted Majority algorithm (DWM) penalizes a wrong prediction of the learner by decreasing the weight with a pre-determined factor. The weight for each leaner is calculated as the log-normalized reciprocals of the weighted errors in the algorithm Learn++.NSE.

new model—when and how to add a new model to the ensemble is important to the effective and fast adaptation to the environment changes. Some conventional approaches build a new model for every new chunk of data. More commonly, a new model is added if the ensemble performance on the current data point(s) is wrong or below expectation. The training data usually are the most recent samples.

ensemble pruning—in practice, the ensemble size is usually bounded due to the limitation of resources. A simple pruning strategy is to remove the worst performance model whenever the upper bound of the ensemble is reached. The effective ensemble size can also be dynamically determined by approaches, such as instance based pruning and ordered aggregation. The DWM algorithm removes a model from the ensemble if its weight is below a threshold.

More recent advances on learning in streaming data with imbalanced classes under nonstationary environments include an ensemble-based online learning algorithm to address the problem of class evolution, i.e., the emergence and disappearance of classes with the streaming data.

Embodying systems and methods provide an ensemble-based passive approach to selecting a model for prediction of an industrial asset's performance (e.g., a power plant). An embodying algorithm is developed based on the Dynamic and Online Ensemble Regression algorithm (DOER). Embodying algorithms include significant modifications over a conventional DOER to meet specific requirements of industrial applications. Embodying algorithms provide an overall better performance on multiple synthetic and real (industry applications) data sets when compared to conventional modeling algorithms.

Modifications to a conventional DOER included in embodying processes include at least the following three aspects. First, a data selector unit is introduced into the conventional DOER, this data selector unit adds an ability to select data (e.g., filter) for model updating, rather than the conventional approach that solely relies on only recent data. A long-term memory is added, based on reservoir sampling, to store previous historical data knowledge. Similar data points (clustered within a predetermined threshold) are selected by applying filtering to the long-term memory data and the current data (referred to as short-term memory), as the training set for a new model. Thus, embodying processes are effective to make the algorithm adapt to abrupt change in a faster way, for example, responsive to a sudden change. This adaptiveness is useful when data points before the change point are no longer representative of the real information following the change point (i.e., resulting from a change in the industrial asset's performance). By way of example, a common phenomenon in power plants is that water wash cleaning results in a significant improvement in compressor or turbine efficiency. Such maintenance can lead to a sudden increase of power output, which makes the previously learned power plant model no longer effective.

Second, the conventional DOER algorithm uses an online sequential extreme learning machine (OS-ELM) as the base model in the ensemble. However, one drawback of the learning strategy of the conventional OS-ELM is that its performance is not stable due to a possibility for non-unique solutions. To address this issue, embodying systems and methods introduce a regularization unit to the initial model build training block of the OS-ELM. This regularization unit can penalize larger weights and achieve better generalization. An analytically solvable criterion is used to automatically select the regularization factor from a given set of candidates. In some implementations the number of neurons can then be set as a large number (e.g., about 500) without the need of further tuning. Under this implementation the base model becomes parameter free, which reduces the burden of parameter tuning. Under conventional approaches parameter tuning is time consuming and requires manual involvement.

Third, embodying processes extend the conventional DOER algorithm for problems with multiple outputs. Embodying systems and processes can include the use of online sequential extreme learning machines (OS-ELM) as the base model in the ensemble, which is an online realization of ELM having the advantage of very fast training and ease of implementation. Other base models (e.g., random forests, support vector machines, etc.), can also be used as the base model.

Extreme learning machine (ELM) is a special type of feed-forward neural network. Unlike in other feed-forward neural networks (where training the network involves finding all connection weights and bias), in ELM connections between input and hidden neurons are randomly generated and fixed so that the neural network not need to be trained. Thus, training an ELM becomes finding connections between hidden and output neurons only, which is simply a linear least squares problem whose solution can be directly generated by the generalized inverse of the hidden layer output matrix. Because of such special design of the network, ELM training becomes very fast. ELM has better generalization performance than other machine learning algorithms including SVMs and is efficient and effective for both classification and regression.

Consider a set of M training samples, {(xᵢ,yᵢ)}ᵢ₌₁^{M}, xᵢϵ [symbol] ^{d}, yᵢϵ [symbol] ^{k}. Assume the number of hidden neurons is L. Then the output function of ELM for generalized single layer feedforward neural networks is

$$f ( x ) = {\sum }_{i = 1}^{L} {β}_{i} {h}_{i} ( x ) = H ( x ) β \qquad ( 1 )$$

where hᵢ(x)=G(wᵢ, bᵢ, x), wᵢϵ [symbol] ^{M}, bᵢϵ [symbol] ^{k}, is the output of i^{th} hidden neuron with respect to the input x;

G(w, b, x) is a nonlinear piecewise continuous function satisfying ELM universal approximation capability theorems;

βᵢ is the output weight matrix between i^{th} hidden neuron to the k≥1 output nodes; and

H(x)=[h₁(x), . . . , h_{L}(x)] is a random feature map mapping the data from d-dimensional input space to the L-dimension random feature space (ELM feature space).

For batch ELM, where all samples are available for training, the output weight vector can be estimated as the least-squares solution of Hβ=Y, that is, \hat{β}=H^{†}Y, where H^{†} is the Moore-Penrose generalized inverse of the hidden layer output matrix, which can be calculated through orthogonal projection method: H^{†}=(H^{T}H)⁻¹ H^{T}.

To achieve better generalization and stable solutions, a regularized factor, C, which can be estimated analytically, is added to the diagonal elements of H^{T}H. Thus, the Moore-Penrose generalized inverse of H is calculated as (H^{T}H+I/C)⁻¹H^{T}. To select C, the leave-one-out cross-validation error for a range of candidates Cⱼ (j=1, . . . , N) can be calculated as

$${E}_{LOOCV}^{j} = {\sum }_{j = 1}^{N} {( \frac{{y}_{j} -}{1 -} )}^{2} ,$$

where yⱼ and [symbol] are the j^{th} sample target and predicted values and [symbol] is the j^{th} value of the diagonal of HAT=H(H^{T}H+I/C)⁻¹H^{T} By applying singular value decomposition, H can be represented as H=UΣV^{T}. HAT can then be rewritten as

$$HAT = U {Σ ( {Σ}^{T} Σ + I / C )}^{- 1} {Σ}^{T} {U}^{T} , \\ where {Σ ( {Σ}^{T} Σ + I / C )}^{- 1} {Σ}^{T} = [ \begin{matrix}\frac{{σ}_{11}^{2}}{{σ}_{11}^{2} + \frac{1}{C}} & … & 0 \\ ⋮ & ⋱ & ⋮ \\ 0 & … & \frac{{σ}_{NN}^{2}}{{σ}_{NN}^{2} + \frac{1}{C}}\end{matrix} ] .$$

The optimal C is selected as the one that corresponds to the minimal E_{LOOCV}.

Online sequential ELM (OS-ELM), is a variant of classical ELM, which has the capability of learning data one-by-one or chunk-by-chunk with a fixed or varying chunk size. OS-ELM involves two learning phases, initial training and sequential learning.

Initial model build block (phase 1): choose a small chunk of initial training samples, {(xᵢ, yᵢ)}ᵢ₌₁^{M}^{₀}, where M₀≥L, from the given M training samples; and calculate the initial output weight matrix, β⁰, using the batch ELM formula described above.

Sequential continuous learning block (phase 2): for (M₀+k+1)′ training sample, perform the following two steps.

(1) calculate the partial hidden layer output matrix:

Hₖ₊₁=[h₁(x_{M}_{₀}₊ₖ₊₁), . . . ,h_{L}(x_{M}_{₀}₊ₖ₊₁)], and set tₖ₊₁=y_{(M}_{₀}₊ₖ₊₁₎^{T}; and

(2) Calculate the output weight matrix:

β^{k+1}=β^{k}+Rₖ₊₁Hₖ₊₁(tₖ₊₁^{T}−Hₖ₊₁^{T}β^{k}), where,

$${R}_{k + 1} = {R}_{k} - \frac{{R}_{k} {H}_{k + 1} {H}_{k + 1}^{T} {R}_{k}}{1 + {H}_{k + 1}^{T} {R}_{k} {H}_{k + 1}}$$

for k=0, 1, 2, . . . , M−M₀+1.

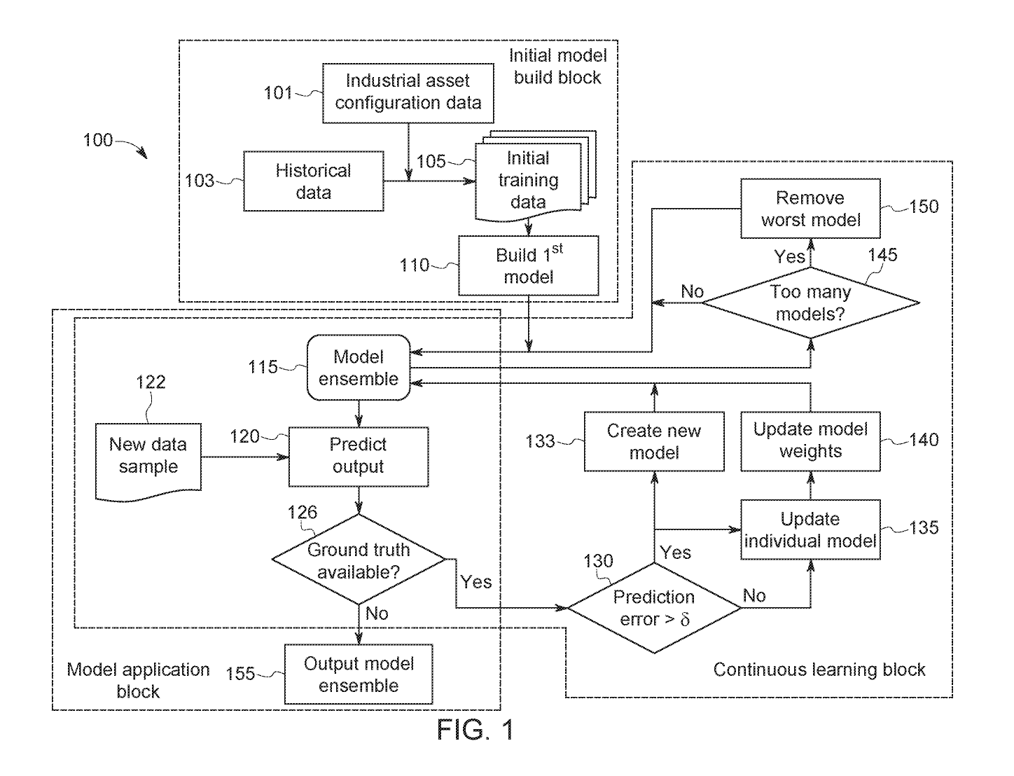

FIG. 1 depicts ensemble regression algorithm (ERA) 100 in accordance with embodiments. ERA 100 implements an online, dynamic, ELM-based approach. The ERA includes an initial model build block, an online continuous learning block, and a model application block. The online continuous learning block includes model performance evaluation and model set update. It should be readily understood that the continuous learning block can operate at distinct intervals of time, which can be predetermined, with a regular and/or nonregular periodicity.

During the initial model build block, initial training data is received, step 105. The initial training data can include, but is not limited to, industrial asset configuration data that provides details for parameters of the actual physical asset configuration. The training data can also include historical data, which can include monitored data from sensors for the particular physical asset and monitored data from other industrial assets of the same type and nature. The historical data, asset configuration data and domain knowledge can be used to create an initial model. Filtering can be applied to these data elements to identify useful data from the sets (e.g., those data elements that impact a model). The initial training data, which can be expressed as

Dinit={(xₜ,yₜ)|t=1, . . . T₁,xₜϵ [symbol] ^{d},yₜϵ [symbol] ^{r}},

where d≥1 and r≥1 are the dimensions for input and output variables, respectively.

A first model (m1) is created, step 110. This first model is based on the training data. As part of the continuous learning block, the first model is added to a model ensemble, step 115. In accordance with embodiments the model ensemble can be a collection of models, where each model implements a different modeling approach. The ERA algorithm predicts a respective performance output for each model(s) of the model ensemble, step 120.

The predicted performance is evaluated/processed with new monitored data samples received, step 122, from the industrial asset. This stream of monitored data samples can be combined with accurate, observed (i.e., “ground truth”) data, with subsequent filtering to be used by the continuous learning block to update/create models for addition to the model ensemble. At step 130, an error difference (delta 6) is calculated between the predicted performance output and the new data samples. If the error difference is less than or equal to a predetermined threshold, ERA algorithm returns to the model ensemble, where each individual model is updated 135 and its corresponding weight is adjusted based on its performance 140.

If the error difference is determined at step 130 to be greater than the predetermined threshold, a new model is created, step 133. This new model is then added to the model ensemble. Additionally, each individual model is updated 135 and its corresponding weight is adjusted based on its performance 140.

In accordance with embodiments, a determination is made as to whether the quantity of models in the model ensemble exceeds a predetermined quantity, step 145. If there are too many models, the least accurate model is removed, step 150

The new data samples (received at step 122) can include ground truth. A determination is made as to whether ground truth data was available, step 126, in predicting the output (step 120). If there was ground truth data available, then the continuous learning block portion of process 100 continues to step 130, as described above.

As part of the model application block, process 100 can push the model ensemble out to replace a fielded model currently being implemented in a performance diagnostic center. If ground truth was not available (step 126) to be used in generating an output prediction (step 120), then the model application block can push the model ensemble, step 155, out to the performance diagnostic center to perform forecasting tasks.

In accordance with embodiments, ERA algorithm 100 maintains two data windows with fixed size ws. The first data window is called short term memory D_{S}, which contains the most recent ws data points from the stream. The other data window is known as long term memory D_{L}, which collects data points from the stream based on reservoir sampling. Specifically, this sampling strategy initially takes the first ws data points to the reservoir. Subsequently, the t data point is added to the reservoir with the probability ws/t. A randomly selected point is then removed from the reservoir. For a new data point to lead to the creation of a new model, its probability is 1. By maintaining both long and short term memories, an embodying ERA algorithm can take advantage of both the previous and most recent knowledge.

Each model of the model ensemble can be associated with a variable, named Life, which counts the total number of online evaluations the model has seen so far. Thus, Life is initialized as 0 for each new model. The mean square error (MSE) of the model on the data points that it is evaluated on (with upper threshold≤ws) is denoted as a variable, mse, which is also initially set as 0. The voting strategy of the ensemble is weighted voting, and the weight of the first model is 1.

In the online learning block, the ensemble generates the prediction [symbol] for a new input point xt, based on weighted voting from all of its components,

[symbol]

=Σᵢ₌₁^{M}wᵢoᵢ/Σᵢ₌₁^{M}wᵢ (2)

where M is the total number of models in the ensemble;

wᵢ is the weight of the model mᵢ; and

oᵢ is the output from the model mᵢ.

Correspondingly, the prediction error of model mi on the new data point is obtained as,

eᵢ^{t}=Σⱼ₌₁^{r}(yₜ^{j}−oₜ^{j})² (3)

For each model mᵢ, its weight is adjusted based on mseᵢ, as aforementioned. With the calculated squared error eᵢ^{t}, the variable msei is calculated as,

$${mse}_{i}^{t} = \{ \begin{matrix}0 & if {life}_{i} = 0 \\ \frac{{life}_{i} - 1}{{life}_{i}} \times {mse}_{i}^{t - 1} + \frac{{e}_{i}^{t}}{{life}_{i}} & if 1 \leq {life}_{i} \leq ws \\ {mse}_{i}^{t - 1} + \frac{{e}_{i}^{t}}{ws} - \frac{{e}_{i}^{t - ws}}{ws} & if {life}_{i} > ws\end{matrix} \qquad ( 4 )$$

Accordingly, the weight wi for the model mi is updated as,

$${w}_{i} = {e}^{- ( \frac{{mse}_{i}^{t} - median ( {Ψ}^{t} )}{median ( {Ψ}^{t} )} )} \qquad ( 5 )$$

where Ψ^{t}=(mse₁^{t}, . . . , mseₘ^{t}) is the set of the MSEs of all models in the ensemble and median(Ψ^{t}) takes the median of MSEs of all models. As shown in Equation 5, the impact of a model on the ensemble output decreases exponentially with its MSE larger than the median. Models with smaller MSEs than the median will contribute more to the final ensemble output.

Following the weight updates, the models in the ensemble are all retrained by using the new point (xₜ, yₜ), based on the updating rules of OS-ELM.

To determine whether a new model is needed to be added to the ensemble, the algorithm evaluates the absolute percentage error of the ensemble on the new point (xₜ, yₜ),

$${APE}_{j} = abs ( \frac{- {y}_{j}}{{y}_{j}} ) \times 100 , j = 1 , … , r \qquad ( 6 )$$

In accordance with embodiments, if APEⱼ (j==1, . . . , r) is greater than a threshold δⱼ, a new model is created. Accordingly, a new model is added to the model ensemble if none of the models achieve the predetermined accuracy. Note that the thresholds could be different for different outputs based on the specific requirements. Initially, the variables Life and mse for the new model are set to 0, and the weight assigned to the model is 1.

The training data for the new model are selected from the long term and short term memories, i.e., D_{L} and D_{S}, based on the similarity of the points in these two sets and the new data point (xₜ, yₜ). To calculate such distances, both input and output variables are considered, which leads to an extension vector z=(x, y)=(x₁, . . . , x_{d}, y₁, . . . , yᵣ). Given the candidate set combined from D_{L} and D_{S}, i.e., D_{C}=(z₁, . . . , z_{2×ws}), and the current data point zₜ=(xₜ, yₜ), the distance between zₜ and zⱼϵD_{C} is calculated as,

dis(zₜ,zⱼ)=Σₖ₌₁^{d}Wₖ(xₜ^{k}−xⱼ^{k})²+Σₗ₌₁^{r}W_{d+l}(yₜ^{l}−yⱼ^{l})₂ (7)

where W=(W₁, . . . , W_{d+r}) are the weights for the input and output variables. In some implementations, a larger weight (e.g., perhaps 5 times larger) is assigned to the output variables than input variables to emphasize the impact of hidden factors, such as operation conditions and component efficiency.

A threshold τ can be defined as the mean of all these distances minus the standard deviation. All candidate points from D_{C} with their distances to the current data point less than τ are included in the training set. If the total number of points in the training set is too small, e.g., less than ws, additional candidate points can be added to the training set based on the order of their distances to the current data point till the training set has ws data points.

In accordance with embodiments, the maximum number of models in the ensemble is fixed. Therefore, if the number of models is above a threshold ES because of the addition of a new model, the worst performance model, in terms of the variable mse, will be removed from the ensemble.

After all the updates discussed above are done, the weights of the models can be normalized.

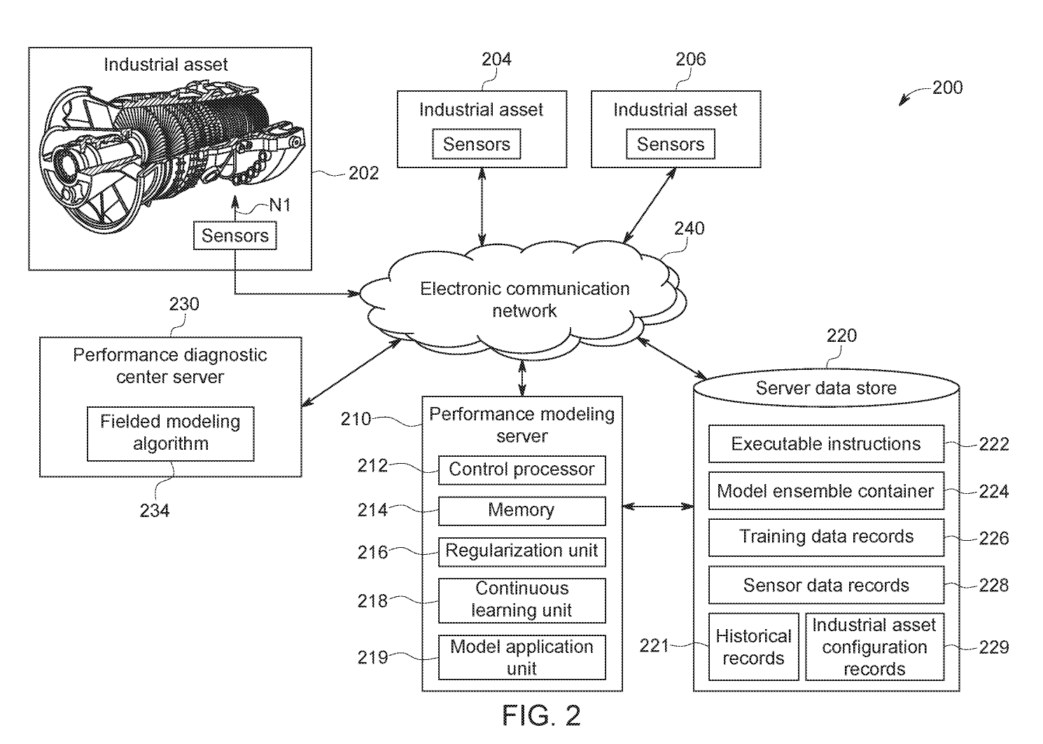

FIG. 2 depicts system 200 for implementing an ensemble-based passive approach to model industrial asset performance in accordance with embodiments. System 200 can include one or more industrial assets 202, 204, 206, where industrial asset 202 can be a turbine. Each industrial asset can include one or more sensors that monitor various operational status parameters of operation for the industrial asset. The quantity of sensors, the parameter monitored, and other factors can vary dependent on the type and nature of the mechanical device itself. For example for a turbine engine, sensors can monitor turbine vane wear, fuel mixture, power output, temperature(s), pressure(s), etc. It should be readily understood that system 200 can include multiple monitored industrial assets of any type and nature. Further, embodying systems and methods can be implemented regardless of the number of sensors, quantity of data, and format of information received from monitored industrial assets. Each industrial asset can be in communication with other devices across electronic communication network 240.

In accordance with embodiments, performance modeling server 210 can obtain access models from model ensemble container 224, training data records 226, and sensor data records 228 from server data store 220. Server 210 can be in communication with the data store across electronic communication network 240, and/or in direct communication.

Electronic communication network can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 240.

Server 210 can include at least one server control processor 212 configured to support embodying ensemble-based passive approaches to model industrial asset performance techniques by executing executable instructions 222 accessible by the server control processor from server data store 220. The server can include memory 214 for, among reasons, local cache purposes.

Server 210 can include regularization unit 216 that can introduce into the initial model build block automatic selection of a regularization factor based on penalization of larger weighting so that the OS-ELM can operate at an increased speed over conventional approaches without manual intervention. Continuous learning unit 218 can evaluate performance of ensemble model members in comparison to a predetermined threshold. Based on the result of the comparison a determination can be made to create a new model for the ensemble, or access another model in the ensemble for evaluation. Model application unit 219 can select a member of the model ensemble to have weighting factors updated. The model application unit can push a model to a performance diagnostic center to replace a fielded model that is being used to perform evaluation of an industrial asset.

Model ensemble container 224 can include one or more models, where each model can implement a different algorithm to model the performance of an industrial asset. The model ensemble container can include partitions that represent a type of industrial asset (i.e., aircraft engine, power generation plant, locomotive engine, etc.). Within each partition can be multiple models, where each model implements a different algorithm to predict performance for that type of industrial asset.

Training data records 226 can contain records of respective training data for each of the types of industrial assets. This training data can include ground truth data for the operation of one or more types of industrial asset(s). Sensor data records 228 can include sensor data obtained from each respective industrial asset. Data store 220 can include historical records 221, which contain monitored data from sensors. Industrial asset configuration records 229 includes details for parameters of the actual physical asset configuration of various industrial assets.

Each industrial asset 202, 204, 206 can be in communication with performance diagnostic center server 230 across an electronic communication network, for example network 240. The industrial assets provide sensor data to the performance diagnostic center. This sensor data is analyzed under computer control by fielded modeling algorithm 234. The results of this analysis can be applied to determine a predictive functional state of the respective industrial assets (e.g., efficiency, malfunction, maintenance scheduling, etc.). As should be readily understood, a particular algorithmic approach can be implemented in a fielded modeling algorithm for each type and/or nature of industrial asset. Further, there can be multiple performance diagnostic centers, each dedicated to analyzing a type/nature of industrial asset.

Embodying systems and processes analyze and/or compare the accuracy of fielded modeling algorithm 234 with respect to modeling algorithms of model ensemble container 224. The result of the comparison is determinative in whether the fielded modeling algorithm should be replaced by one of the algorithms in the ensemble. For example, maintenance activity (or lack thereof), repair, part wear, etc. could contribute to the fielded modeling algorithm no longer providing adequate accuracy in its predictions. If the fielded modeling is to be replaced, the selected modeling algorithm of the ensemble is pushed by performance modeling server 210 to performance diagnostic center server 230, where the fielded modeling algorithm is substituted with the selected modeling algorithm.

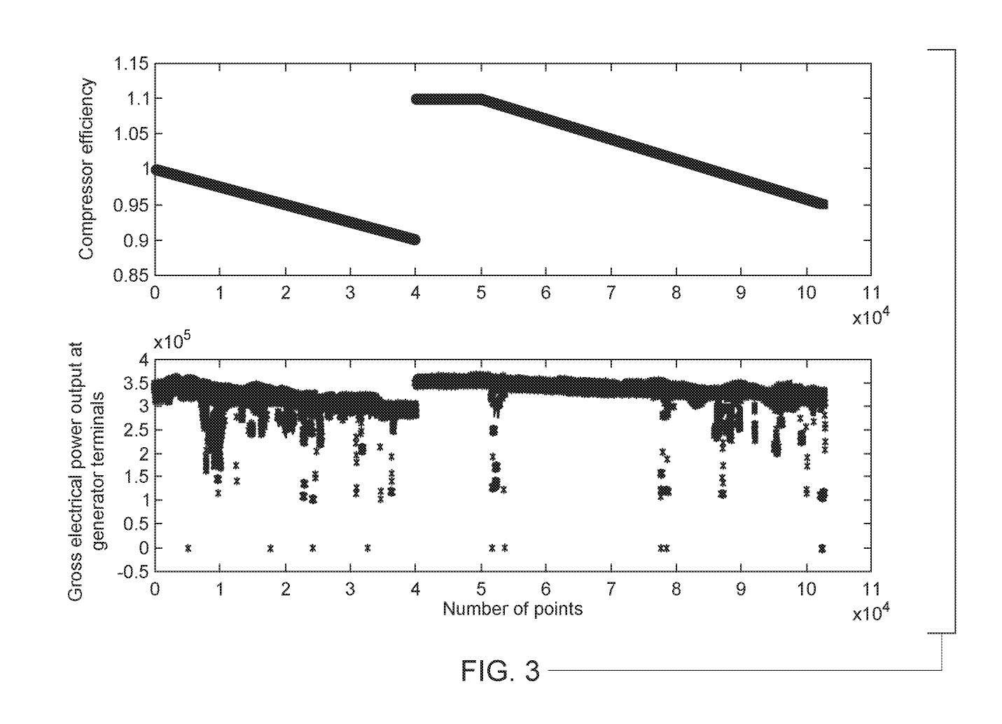

FIG. 3 depicts an example of an industrial asset data (simulated combined with real monitored data) used in validating an ensemble of models in accordance with embodiments. The simulated data is for a compressor power generating system, and includes compressor efficiency 310 and gross electrical power output 320. This simulated data equates to effects of a water wash of the compressor and the gradual parts wear over a one-year period.

The data sets include nine input variables, known as compressor inlet temperature, compressor inlet humidity, ambient pressure, inlet pressure drop, exhaust pressure drop, inlet guide vane angle, fuel temperature, compressor flow, and controller calculated firing temperature. The output variables are the gross power output and net heat rate with respect to generator power.

By adjusting the compressor efficiency, algorithm performance on drift with different patterns and rates can be evaluated. Compressor efficiency 310 first linearly decreases from 1 to 0.9, and then jumps to 1.1 at change point 40,000, which corresponds to the water wash of the engine. The compressor efficiency remains stable at 1.1 for 10,000 points, and decreases again. The compressor efficiency, together with the nine input variables, which are obtained from a real data set, were provided as inputs to a power simulation tool, known as GTP (Gas Turbine Performance). GTP generates the outputs of power output and heat rate for further analysis. As illustrated in the gross electrical power output plot 320, it is clear to see the impact of the change of the compressor on the gross power output from GTP. Particularly, at the change point 40,000, the power output increases significantly because of the significant improvement of the compressor efficiency. There are also some noise or outliers with the data (e.g., data points with power output=0), which are removed from further analysis.

To increase sample population, 500 time variate simulated data series was generated. Each of these data series contains 2,000 data points that are a chunk of the data in FIG. 3. The generated sequences basically belong to two types of changes—sudden and gradual change (265 series with sudden change, and 235 series with gradual change).

For sudden change, the compressor efficiency starts at 1.0 and then gradually decreases to 0.9. Compressor efficiency jumps to 1.1 at the change point, and decreases to 0.9, where it jumps again to 1.1. Efficiency remains level at 1.1 for a while and then gradually drops to 0.95. For gradual change, the compressor efficiency still starts at 1.0 and then gradually decreases to and stay at 0.9. The change point, change range, and stable range are randomly selected for each sequence.

For evaluation by applying a real data set, the evaluation used an ISO corrected base load gross power and the ISO corrected base load gross LHV heat rate from the power plant. The date ranges were taken over a seventeen-month period of operation. The data points were sampled every five minutes, and any record with missing values was removed.

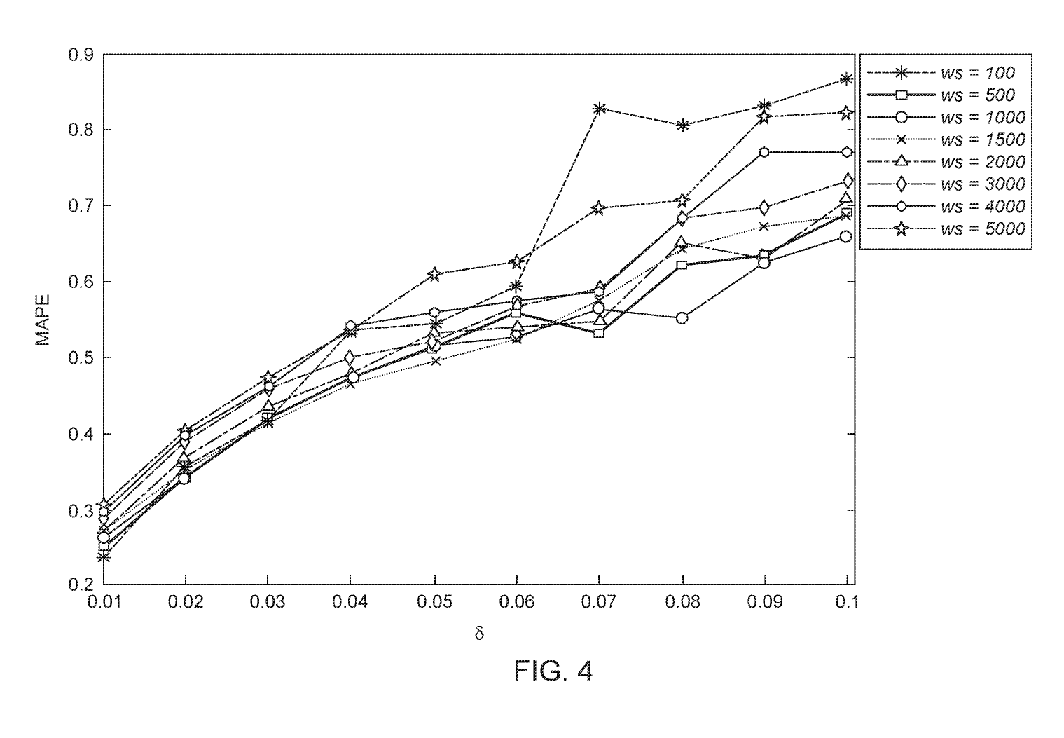

FIG. 4 depicts the sensitivity of an ensemble regression algorithm performance to window size and the threshold δ for adding a new model in accordance with embodiments. The window size ws was set in the range of {100, 500, 1000, 1500, 2000, 3000, 4000, 5000}, and the threshold was varied from 0.01 to 0.1 with a step size of 0.01. Other parameters are fixed. The data set illustrated in FIG. 3 was used for this analysis after outliers were removed.

As can be observed in FIG. 4, in general, the performance of the algorithm, measured in terms of mean absolute percentage error (MAPE), is better for smaller δ. Accordingly, the threshold δ needs to be set to some small value to adapt fast to the changes. It also can be seen from FIG. 4 that the algorithm is not very sensitive to the window size ws when δ is small. As δ becomes larger, either of a very small or a very large window can lead to worse performance.

A determination of the influence of the maximum number of models, ES, on the embodying algorithm performance was conducted for both the simulated data and the real data. For this simulation, the number of models ES varied in the range of 2 to 16, with the MAPE for each value obtained as the mean from 10 runs on the data set. In the simulation window size ws and threshold δ are set at 1000 and 0.04, respectively. In general, there is no significant performance change across the entire range investigated for model number ES. For the simulated data, the increase of model number does not bring improvement to the performance. However, simulations with the real data indicates that algorithm performance becomes slightly better when model number is in the range from 6 to 12. The selection of model number is problem dependent, however, values ranging in [6, 12] is a good start to make sure there are enough models in the model ensemble while reducing computational burden or avoiding overcomplexities.

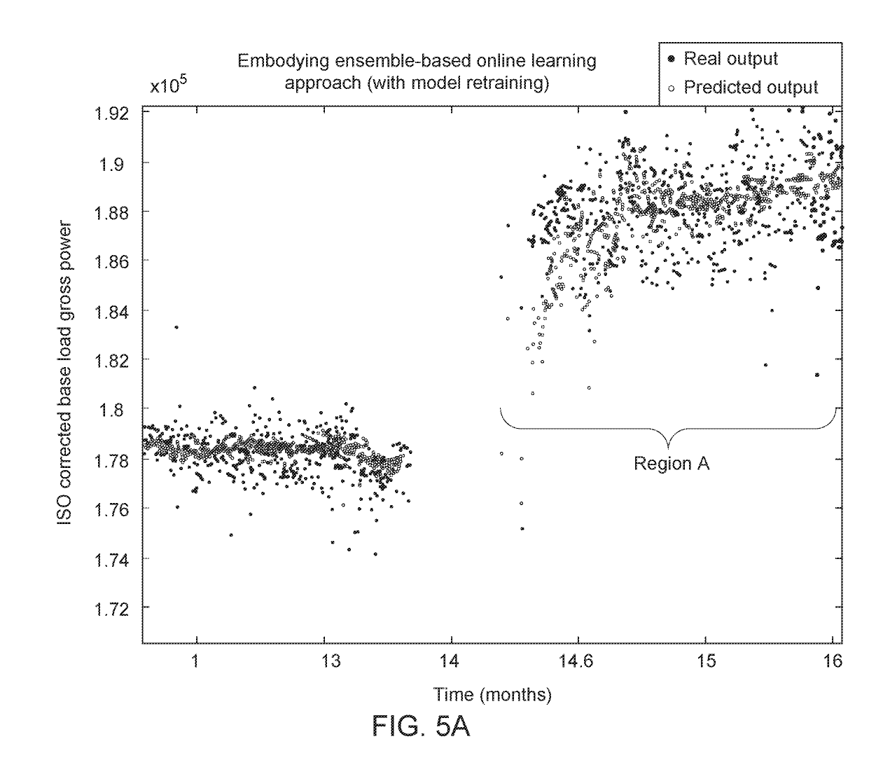

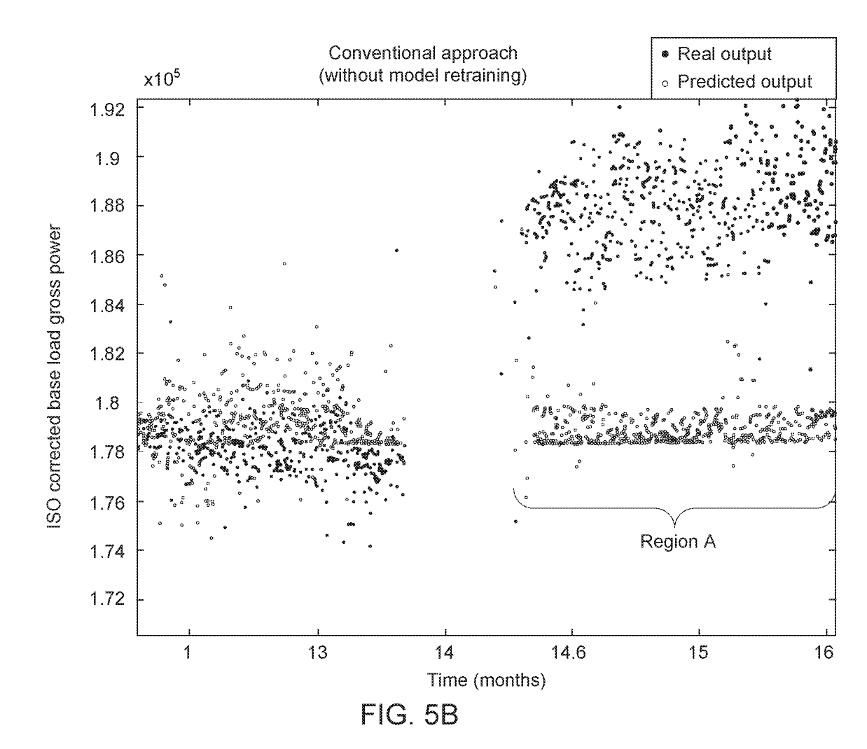

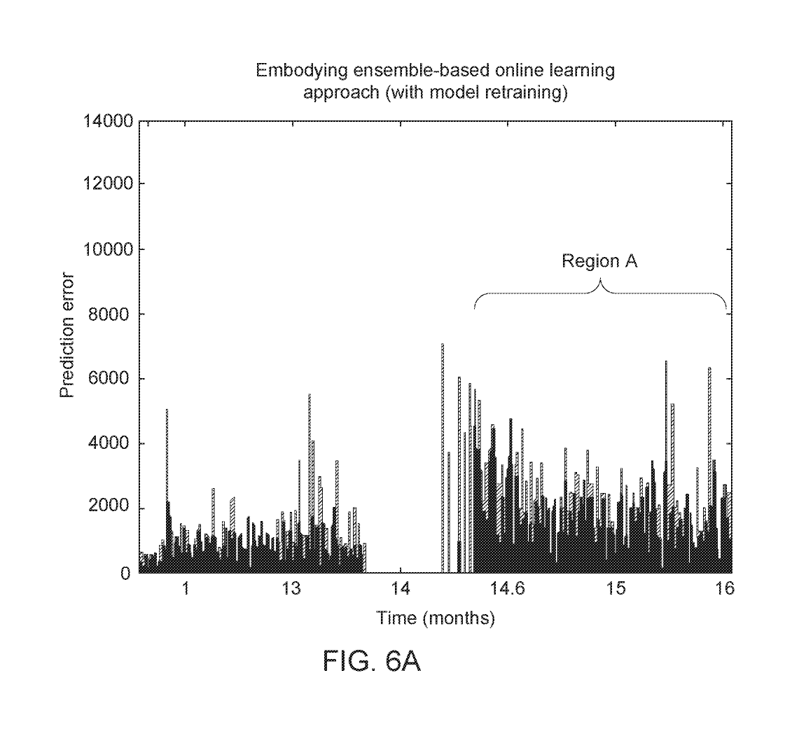

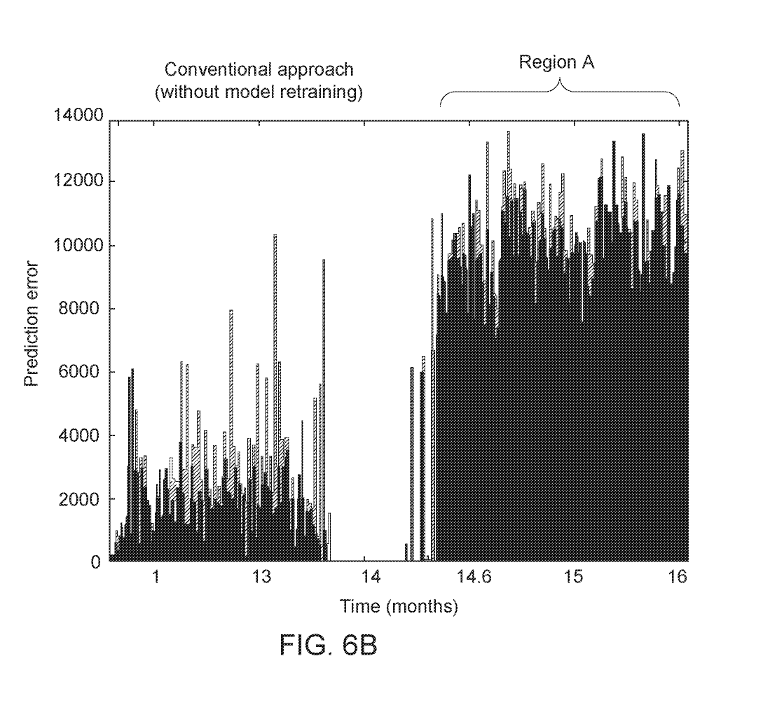

An ELM and an embodying OS-ELM (with and without model update retraining) are benchmarks for comparison. The performance from the original DOER algorithm is also included. To focus this study of FIGS. 5A-6B on concept drift, for each series, only the MAPE for a subset of the series that starts from the 100 points preceding a change appears and lasts for the entire change range was calculate. Each algorithms was run five times on each series. The plots of FIGS. 5A-6B are based on the mean performance on the series. As clearly indicated, the ELM and OS-ELM without retraining do not perform well, with mean and standard deviation as 5.201±1.539 (sudden change) and 8.896±0.879 (gradual change), and 5.148±1.244 (sudden change) and 4.526±1.785 (gradual change), respectively. The MAPEs for the DOER are 2.219±1.790 (sudden change) and 1.370±1.420 (gradual change).

In comparison, the MAPEs for the modified DOER are 2.116±1.681 (sudden change) and 1.546±1.506 (gradual change), which are slightly better for series with sudden changes, but deteriorate slightly for gradual change cases. The inclusion of LTM increase the algorithm's capability to faster adapt to sudden changes due to operation condition change or maintenance action. The means and standard deviations of the embodying algorithm on the entire non-training series are 0.813±0.109 (sudden change) and 0.474±0.031 (gradual change), which meet 1% expectation in practice.

Similarly, the performance of DOER and the embodying algorithm on the real data set when water wash maintenance action is performed (either online or offline) is an important factor leading to concept drift. The means and standard deviations of MAPEs for the embodying algorithm on power output and heat rate are 1.114±0.067 and 0.615±0.034, respectively. In comparison, the DOER achieves 1.278±0.024 and 0.774±0.018 on these two outputs.

FIG. 5A depicts performance of an ensemble regression algorithm over time with retraining in accordance with embodiments on the real data set. Similarly FIG. 5B depicts performance of the ensemble regression algorithm over time, but without retraining. FIG. 6A depicts prediction error of an ensemble regression algorithm over time with retraining in accordance with embodiments. Similarly FIG. 6B depicts prediction error of an ensemble regression algorithm over time, but without retraining

FIG. 5A illustrates that over time Region A, the predicted output of the embodying ensemble-based approach (with retraining) tracks real output data from industrial assets at a substantially significant improvement over the conventional approach (without retraining) illustrated in FIG. 5B. Similarly, FIG. 6A illustrates that over time Region A, the error of prediction of the embodying ensemble-based approach (with retraining) is a substantially significant improvement over the conventional approach (without retraining) illustrated in FIG. 6B.

Embodying systems and methods provide an online ensemble-based approach for complex industrial asset performance modeling, which is important for real-time optimization and profit maximization in the operation of an industrial asset (e.g., power generating station, locomotives, aircraft and marine engines, etc.). By comparing a fielded modeling algorithm to algorithmic members of ensemble, a determination can be made as two whether the fielded modeling algorithm should be replaced. If replacement is determined, the performance modeling server pushes a selected member of the ensemble to the performance diagnostic center server, where the pushed modeling algorithm replaces the fielded modeling algorithm.

The continuous learning capability (i.e., algorithm retraining) of the embodying approaches makes possible to automatically update model(s) in response to concept drifts due to component degradation, maintenance action, or operation change. Embodying processes can consistently meet the requirements in real plant operation, with the overall MAPE prediction error <1% on both simulated and real data. Embodying processes are scalable to different configured plants and easiness for implementation.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform a method of continuous modeling of an industrial asset performance by ensemble-based online algorithm retraining applying an online learning approach to evaluate whether a fielded modeling algorithm should be replaced with an algorithm from the ensemble, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method of continuously modeling industrial asset performance, the method comprising:
an initial model build block creating a first model based on a combination of an industrial asset historical data, configuration data and training data; and
a continuous learning block predicting performance of one or more members of an ensemble of models by evaluating a result of the one or more ensemble members to a predetermined threshold.

2. The method of claim 1, the creating a first model including filtering at least one of the historical data, configuration data, and training data.

3. The method of claim 1, the evaluating of model ensemble members occurring at one of real time and predetermined intervals.

4. The method of claim 1, the continuous learning block including creating a new model based on the prediction.

5. The method of claim 1, the continuous learning block including:
receiving a fielded modeling algorithm from a performance diagnostic center;
evaluating performance of the fielded modeling algorithm;
calculating a difference between the output of the fielded modeling algorithm and at least an output of one of the ensemble model members; and
comparing the difference to the predetermined threshold.

6. The method of claim 1, a model application block including:
selecting a model from the one or more members of an ensemble of models based on a result of the performance prediction; and
pushing the selected model ensemble member to a performance diagnostic center.

7. The method of claim 1, including:
determining if a quantity of models in the model ensemble is in excess of a predetermined quantity; and
if the quantity is in excess of the predetermined quantity, then removing a least accurate model ensemble member from the model ensemble.

8. A non-transitory computer readable medium having stored thereon instructions which when executed by a control processor cause the control processor to perform a method of continuously modeling industrial asset performance, the method comprising:
an initial model build block creating a first model based on a combination of an industrial asset historical data, configuration data and training data; and
a continuous learning block predicting performance of one or more members of an ensemble of models by evaluating a result of the one or more ensemble members to a predetermined threshold.

9. The medium of claim 8 containing computer-readable instructions stored therein to cause the control processor to perform the method, the creating a first model including filtering at least one of the historical data, configuration data, and training data.

10. The medium of claim 8 containing computer-readable instructions stored therein to cause the control processor to perform the method, the evaluating of model ensemble members occurring at one of real time and predetermined intervals.

11. The medium of claim 8 containing computer-readable instructions stored therein to cause the control processor to perform the method, the continuous learning block including creating a new model based on the prediction.

12. The medium of claim 8 containing computer-readable instructions stored therein to cause the control processor to perform the method, including:
receiving a fielded modeling algorithm from a performance diagnostic center;
evaluating performance of the fielded modeling algorithm;
calculating a difference between the output of the fielded modeling algorithm and at least an output of one of the ensemble model members; and
comparing the difference to the predetermined threshold.

13. The medium of claim 12 containing computer-readable instructions stored therein to cause the control processor to perform the method, including:
selecting a model ensemble model based on a result of the comparison; and
pushing the selected model ensemble member to the performance diagnostic center.

14. The medium of claim 8 containing computer-readable instructions stored therein to cause the control processor to perform the method, including:
determining if a quantity of models in the model ensemble is in excess of a predetermined quantity; and
if the quantity is in excess of the predetermined quantity, then removing a least accurate model ensemble member from the model ensemble.

15. A system for continuously modeling industrial asset performance, the system comprising:
a server including a control processor, the server in communication with a data store;
the server including a regularization unit configured to implement an initial model build block;
the server including a continuous learning unit configured to implement a continuous learning block;
the server including a model application unit configured to implement a model application block;
the data store including:
a model ensemble container that contains member algorithms, each of the member algorithms configured to predict a respective performance of the one or more industrial assets based on respective sensor data records, and each of the model ensemble members implementing a different modeling approach to model the industrial asset;
a historical data record containing prior monitored data obtained by sensors in an industrial asset;
an industrial asset configuration record containing parameters of a physical asset configuration of the industrial asset
the control processor configured to access executable instructions that cause the control processor to perform a method, the method comprising:
an initial model build block creating a first model based on a combination of an industrial asset historical data, configuration data and training data; and
a continuous learning block predicting performance of one or more members of an ensemble of models by evaluating a result of the one or more ensemble members to a predetermined threshold.

16. The system of claim 15, the executable instructions causing the control processor to perform the method, the creating a first model including filtering at least one of the historical data, configuration data, and training data.

17. The system of claim 15, the executable instructions causing the control processor to perform the method, the evaluating of model ensemble members occurring at one of real time and predetermined intervals.

18. The system of claim 15, the executable instructions causing the control processor to perform the method, the continuous learning block including creating a new model based on the prediction.

19. The system of claim 15, the executable instructions causing the control processor to perform the method, including:
receiving a fielded modeling algorithm from a performance diagnostic center;
evaluating performance of the fielded modeling algorithm;
calculating a difference between the output of the fielded modeling algorithm and at least an output of one of the ensemble model members;
comparing the difference to the predetermined threshold; and
selecting a model ensemble model based on a result of the comparison; and
pushing the selected model ensemble member to the performance diagnostic center.

20. The system of claim 15, the executable instructions causing the control processor to perform the method, including:
determining if a quantity of models in the model ensemble is in excess of a predetermined quantity; and
if the quantity is in excess of the predetermined quantity, then removing a least accurate model ensemble member from the model ensemble.
